(19) United States
(12) Patent Application Publication
(10) Pub. No.: US 2004/0021569 A1
(43) Pub. Date: Feb. 5, 2004

(54) Personnel and resource tracking method and system for enclosed spaces

(76) Inventors: Robert Lepkofker, Oceanside, NY (US); John V. Mizzi, Poughkeepsie, NY (US); Dexing Pang, Smithtown, NY (US); Peter Y. Zhou, Riverside, CA (US)

Correspondence Address: Steven B Pokotilow, Stroock & Stroock & Lavan, 180 Maiden Lane, New York, NY, 10038, US

(21) Appl. No.: 10/432,339

(22) PCT Filed: Nov. 21, 2001
(86) PCT No.: PCT/US01/43383

(51) Int. Cl. G08B 13/14

(52) U.S. Cl. 340/568.1; 340/539.13

(57) ABSTRACT

A system for tracking persons or things. One or more tracking units are associated with persons or things to be tracked. Each tracking unit includes one or more accelerometers and one or more gyroscopes to provide distance and heading or directional information. A master control station (MCS) receives the distance and heading information or location information based thereon. MCS may also display for displaying the location of at least one of the tracking units. The MCS programmed to determine the location based on: determination of a reference point and heading for the at least one tracking unit; data from the accelerometers and gyroscope, which provides distance and direction information; and aggregation of the distance and direction information.

### RELATED U.S. PATENT APPLICATION

The present application claims the benefit of U.S. Provisional Patent Application Serial No. 60/252,599, filed on Nov. 22, 2000, which is incorporated herein by reference in its entirety.

### BACKGROUND OF THE INVENTION

1. Field of the Invention

In general, the present invention relates to an inertial personnel tracking system which can be used in enclosed spaces, such as inside buildings and below ground.

2. Description of Related Art

Various systems exist for locating and tracking persons and items. Such systems typically rely on the now ubiquitous global positioning system (GPS), which consists of twenty-four satellites, each transmitting a radio signal. In general, the location of a GPS receiver is determined through trilateration or, more commonly, triangulation. The GPS receiver measures the distance between it and each of three (or more) satellites based on the travel time of the radio signals from the satellites to the GPS receiver. Each satellite and corresponding distance defines a sphere of possible locations; the intersection of three spheres defined by the three satellites in two points. One of the two points can usually be rejected as an impossible location of the GPS receiver, leaving the second point as the location of the GPS receiver.

However, such GPS systems have disadvantages. Notably, GPS systems require the GPS receiver receive the GPS radio signals from the satellites. Thus, GPS systems will not work where the GPS receiver cannot receive the GPS signals. This disadvantage prevents GPS systems from being used in buildings, tunnels, high-rise metropolitan settings and other enclosed spaces. Accordingly, a need exists for an improved localization and tracking system, particularly one that can locate and track persons and items in enclosed spaces.

### 3. SUMMARY OF THE INVENTION

Methods and systems according to certain embodiments of the present invention satisfy the foregoing and other needs. One or more tracking units are associated with persons or things to be tracked. Each tracking unit includes one or more accelerometers and one or more gyroscopes to provide distance and heading or directional information. A master control station (MCS) receives the distance and heading information or location information based thereon. MCS may also display for displaying the location of at least one of the tracking units. The MCS programmed to determine the location based on: determination of a reference point and heading for the at least one tracking unit; data from the accelerometers and gyroscope, which provides distance and direction information; and aggregation of the distance and direction information.

### BRIEF DESCRIPTION OF THE DRAWINGS

FIG. 1 is a general schematic overview of the system according to one embodiment of the present invention.

FIG. 2a is a schematic of the master control station and the personal tracking unit, according to one embodiment of the present invention.

FIG. 2b is a schematic of the master control station and the personal tracking unit, according to another embodiment of the present invention.

FIGS. 3a and 3b are schematics of chick-in components, according to alternate embodiments of the present invention.

FIG. 4a is a top view of an embodiment of the present invention utilizing an automatic check-in procedure.

FIG. 4b is a schematic illustrating the logical process of back-fitting according to one embodiment of the present invention.

FIG. 4c is a flow chart of the check-in process.

FIG. 5 is a schematic of the message protocol according to one embodiment of the present invention.

### DETAILED DESCRIPTION OF PREFERRED EMBODIMENTS

### Introduction

Realizing the limitations of GPS and triangulation techniques in obtaining accurate reliable three-dimensional personnel location and tracking information within enclosed spaces, methods and systems for inertial tracking, also known as dead reckoning, are provided. Embodiments of the present invention are especially applicable to shielded areas, such as between tall buildings, within buildings and areas in below-grade locations. As will be appreciated, the system is robust enough to continue functioning in light of occasional short radio frequency (RF) dropout or interference episodes. In difficult transmission areas, powerful portable relay stations can be dropped along the way, intermediate the personal tracking units (PTU) worn or carried by the things being tracked and the Master Control Station (MCS) that records and/or displays the data from the PTU, to amplify RF signals and maintain two-way communications between the PTU and MCS.

In general, embodiments utilize co-located gyroscopes and accelerometers to provide data that is used by a processor to accumulate and calculate a path in essentially real-time. Embodiments of the present invention provide a reliable method of providing “check-in,” i.e., the establishment of a starting point and initial heading relative to a known reference, such as a point and direction at or near the MCS. Three distinctly different exemplary methods of check-in are disclosed herein.

While a tri-axial accelerometer is part of the PTU of the inertial tracking system of one embodiment, the present invention contemplates using the same (or different) tri-axial accelerometer to derive individual motion condition analysis by providing vibratory signatures to neural networks per U.S. Pat. No. 5,652,570, issued to Lepkofker, hereby incorporated by reference. Such motion events as walking, riding an elevator, walking up or down stairs, and running are distinguishable without detailed path analysis. The same (or different) accelerometer is also used in certain embodiments to detect falling (high initial acceleration), impact (sharp pulses), motionlessness for a time-out period (“man down”) and the like and are combined with other alarm cues from bio-sensors to alert the MCS and also to turn on attached PTU beacon devices, such as strobe lights, loud audio “chirpers”, vibratory annunciators, electronic beacon signals, and other detectible beacon signals to assist in rapidly locating the wearer in an enclosed space or to alert the wearer of a particular condition.

The display of tracked personnel at the MCS within a building can be facilitated by digitized building plans, if available, for the purpose of displaying both 3-D path as well as building features. If building plans are not available, the position data can be displayed at the MCS in any number of ways, such as, for example, “inferring” the building structure and displaying it along with personnel path information as personnel are moving throughout the structure. For example, horizontal movement infers the existence of a floor, while stair climbing would place a staircase at a particular location; this is handled by display software residing at the MCS. In alternate embodiments, the PTU may include an interface device, such as push buttons, coupled to its processor for the personnel to signal structural features.

It should be understood that although the present embodiments are directed to locating and tracking persons, such as firefighters, the present invention is applicable to locating and tracking animals and items, such as trains, trucks, subway cars, shipping containers, and the like.

### Overview

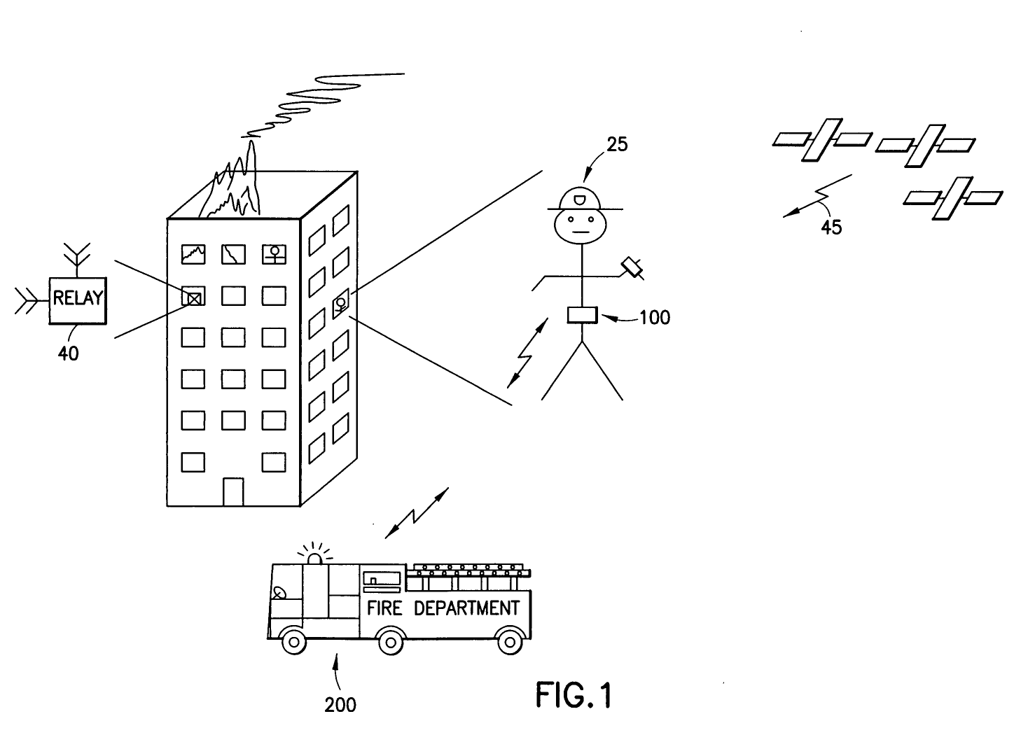

Certain embodiments of the present invention will now be discussed in greater detail with reference to the aforementioned Figures, wherein like reference numerals refer to like components. The schematic of FIG. 1 provides an overview of the components of one embodiment of the present invention and the components' relation to each other. In general, the system of the present embodiment uses gyroscope and accelerometer data to calculate the location of a person 25, such as a firefighter, in any enclosed structure, such as a building, or underground, where GPS radio signals would not be available. It should be understood that the embodiment illustrated in FIG. 1 is for illustration purposes and should not be considered in a restrictive sense.

As described in greater detail below, person 25 wears a personal tracking unit (PTU) 100, that collects data used to calculate the position of the person 25. In the present embodiment, PTU 100 also collects both personal and ambient sensor data. PTU 100 transmits the data to a master control station (MCS) 200, described in greater detail below, via any wireless communication system known in the art. The systems can potentially utilize any number of commercially available wireless data communications solutions available from a number of different service providers. Some examples of the types of wireless data communications interfaces that may be used include: Cellular Digital Packet Data (CDPD), Global System for Mobile Communications (GSM) Digital, Code Division Multiple Access (CDMA), and digital data transmission protocols associated with any of the ‘G’ cellular telephone standards (e.g., 2.5G or 3G). In the present embodiment, the system uses CDPD as the communication technology and user datagram protocol (UDP) with Internet protocol (IP) as the transmission protocol, although other protocols may be used, such as transmission control protocol (TCP). In alternate embodiments, RF, two-way pager or wireless local area network communication is used.

The system may optionally include one or more signal relay stations 40, which serves as a relay or repeater to receive, amplify and re-transmit transmissions between PTUs 100 and MCS 200. Such relay stations 40 may be pre-installed or placed at the time of use by a firefighter, for example.

Two different embodiments of path calculation methods will be described below. Both involve the use of a tri-axial rate gyroscope, such as a silicon vibrating structure gyroscope model CRS-03 from Silicon Sensing Systems Ltd. of Japan. Both also involve the use of a co-located tri-axial accelerometer such as the model MMA1220D from Motorola Semiconductors of Phoenix, Ariz. These devices are preferably incorporated into the PTU 100 carried by the person or object being monitored. Alternatively, a liquid filled type of miniature tilt sensor, for example, like those provided by Nanotron, Inc. can be used as both an accelerometer and as a rate gyro. In other embodiments, three single-axis orthogonal accelerometers may be used instead of a tri-axial accelerometer. Offsets from the MCS to a building facade are determined by the use of laser or ultrasonic rangefinders.

### Exemplary PTUs and MCSs

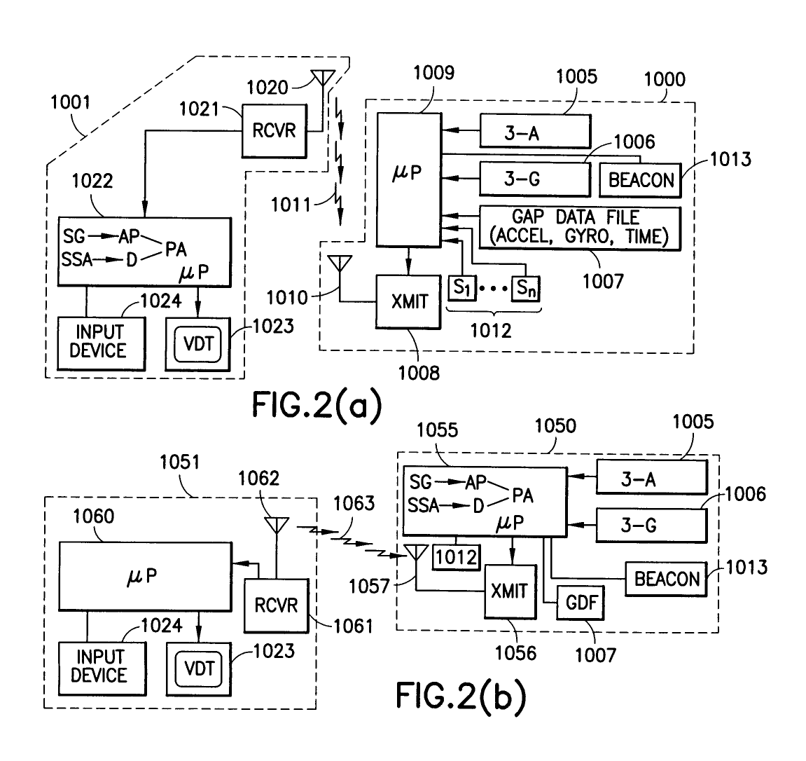

FIG. 2a is a schematic of PTU 1000 and MCS 1001 in an embodiment of the invention where PTU 1000 collects raw accelerometer and gyroscope data and transmits the data to MCS 1001. The MCS 1001, in turn, uses the data to calculate the position of person 25. Specifically, readings from tri-axial accelerometer 1005 and tri-axial gyroscope 1006 are fed to microprocessor and associated memory 1009, which time stamps the readings and simultaneously stores them in gap data file 1007 in memory, such as random access memory (RAM). PTU 1000 preferably includes a local clock, such as a crystal oscillator or other clock not shown. PTU preferable includes a beacon signal generator for generating a detectible alarm and/or beacon signal, as noted above. The beacon 1013 may be activated by the user of the MCS 1001, automatically by the PTU 1000 or manually by the person 25 wearing the PTU 1000. Microprocessor 1009 also transmits the data via transmitter 1008 via a transmission 1011 from antenna 1010 to receiving antenna 1020 of MCS 1001.

A microprocessor 1022 in the MCS 1001 executes the path algorithm (PA) software routine for all PTUs 1000 associated with the MCS 1001. More specifically, the MCS 1001 runs the software routine that performs a single integration of rate gyroscope 1006 data (from receiver 1021) for heading (or direction) and double integration of tri-axial accelerometer 1005 data (from receiver 1021) to determine distance and ultimately PTU location and/or path.

The MCS 1001 is also programmed to create a display on a video display terminal (VDT) 1023. The PTU 1000 preferably continuously over-lays the oldest data with the most recent data so that file 1007 contains a copy of data collected over a predetermined interval, such as one or more seconds. Such data is valuable in recovering from a brief communications interruption. The bandwidth 1011 must be sufficient to keep up with current data as well as transmission of “gap data” during recovery from a short outage. A longer outage that goes beyond the stored data depth would cause an unrecoverable lapse in providing further path tracking of a PTU.

MCS 1001 also includes an interface device, much as a keypad, keyword, and the like, for allowing the user of the system to enter data and instructions.

The PTU 1000 also preferably contains one or more sensors 1012 coupled to the microprocessor 1009, which monitor biological or ambient conditions. Sensors may include those for monitoring physiological parameters of person 25, such as heart rate, body temperature, brain activity, blood pressure, blood flow rate, muscular activity, respiratory rate, blood oxygen, and the like, and/or sensors for monitoring ambient parameters, such as temperature, humidity, motion, speed, carbon nonoxide concentration, existence of particular chemicals and the like. Specialized sensors, such as inertial device-based fall detectors (for example, those utilizing one or more accelerometers) provided by Analog Devices under the trade name ADXL202, are also used. Other exemplary sensors include pulse rate sensors from Sensor Net, Inc., under Model No. ALS-230 and temperature sensors (type NTC) from Sensor Scientific, Inc., under Model No. WM303 or Model No. SP43A. Pulse rate sensors are available from Sensor Net Inc., under Model No. ALS-230; Infrared optical sensors are available from Probe Inc.

The sensor data is preferable analyzed by the microprocessor 1009 to determine whether the sensor data exceeds a pre-set threshold stored in local memory. If a threshold is exceeded, a message is generated and sent to alert the user of the condition. Preferable, the sensor data is also transmitted to the MCS 1001 to alert control/the user. In certain embodiments an alert condition, such as excessive ambient heat or carbon monoxide, cause the beacon 1013 to activate.

An alternate embodiment of the present invention will now be described with reference to FIG. 2b. The present embodiment includes PTU 1050 and MCS 1051 where the PTU 1050 performs path calculation locally using microprocessor 1055 to execute the path algorithm (PA) software routine. While in certain embodiments microprocessor 1055 may use more power than microprocessor 1009 of FIG. 2a, some potential power savings in transmitter 1056 may be realized since transmission 1063 from transmit antenna 1057 to antenna 1062 is a narrower band link as compared to that of FIG. 2a since only the resolved location information is transmitted at appropriate intervals to support location and, if applicable, display 1023 updates. Conversely, receiver 1061 and processor 1060 of MCS 1051 are preferably less elaborate than microprocessor 1022 and receiver 1021 of the embodiment of FIG. 2a. It should be noted that this embodiment is recoverable as to total path after a communications interruption of any length. A small local file in PTU 1050 can be added to visually “fill-in” the display after an interruption (which would otherwise show up as a gap on the display).

In operation the PTU repeatedly (e.g., as fast as possible given the speed of the PTU microprocessor) determines the distance and direction traveled based on the accelerometer and gyroscope. In general, the location information is written to the GDF 1007, transmitted to the MCS, and the process is repeated. The aggregation of the location information essentially is the path of the person wearing the PTU. Such aggregation of location information preferably occurs at the MCS. In certain embodiments, the PTU aggregates location data and transmits it to the MCS at predefined intervals or upon receiving a request from the MCS or upon a manual signal from the wearer, for example when the wearer believes he is in a particularly hazardous area.

The PTU and MCS may include a programmed general purpose computer.

### Check-In Procedure

Typical operation of the foregoing embodiments includes a check-in procedure. The purpose of a check-in procedure is to provide a known starting or reference point and heading relative to the MCS; the path of the person 25 wearing the PTU is “accumulated” relative to this reference point to provide real-time tracking. The real-time location of the individual or object being tracked is then calculated by accumulating path information from the starting point. Not only must the starting location be known, but also the heading of the unit containing the gyroscope and accelerometer elements must be known. This association of a starting location and heading direction with the tracked item is known as check-in. It can be accomplished in a manual or an automated manner. For a fire fighter application, for example, a fully automated technique is desired.

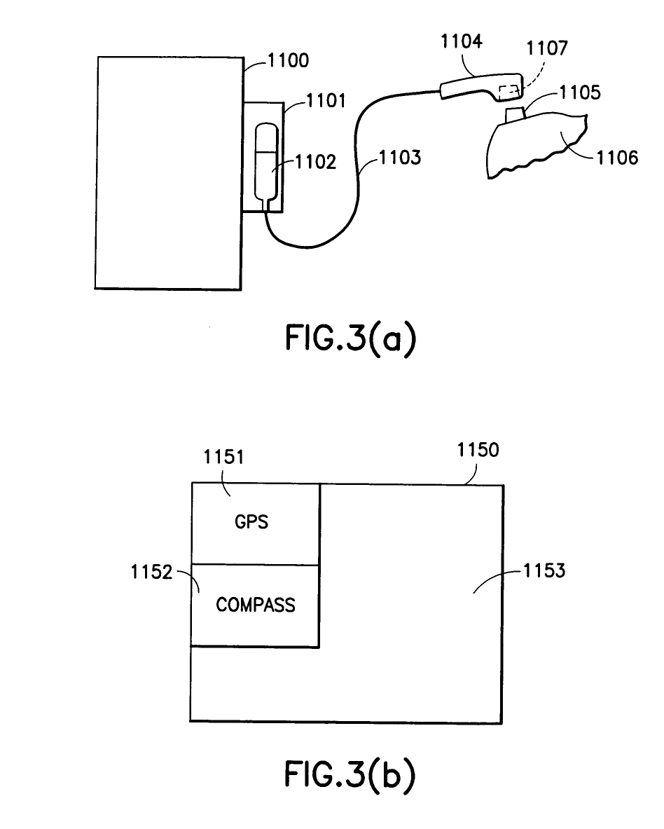

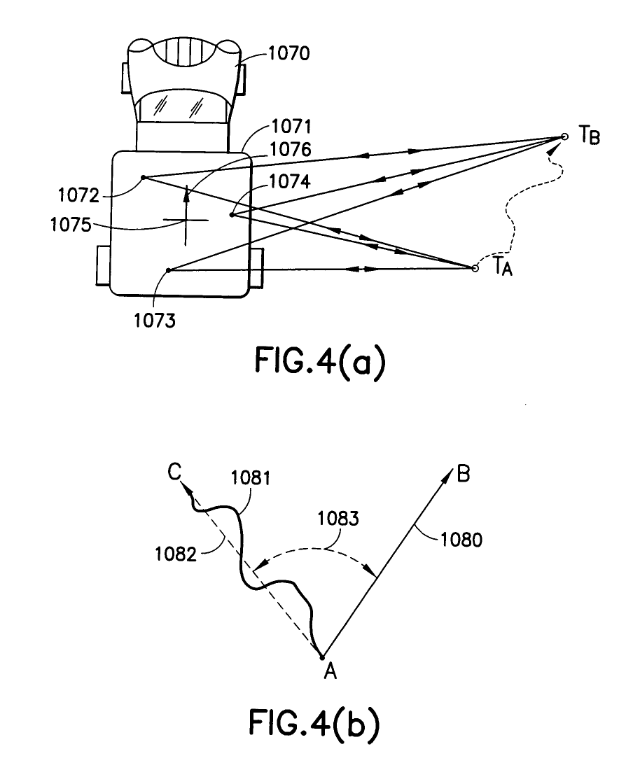

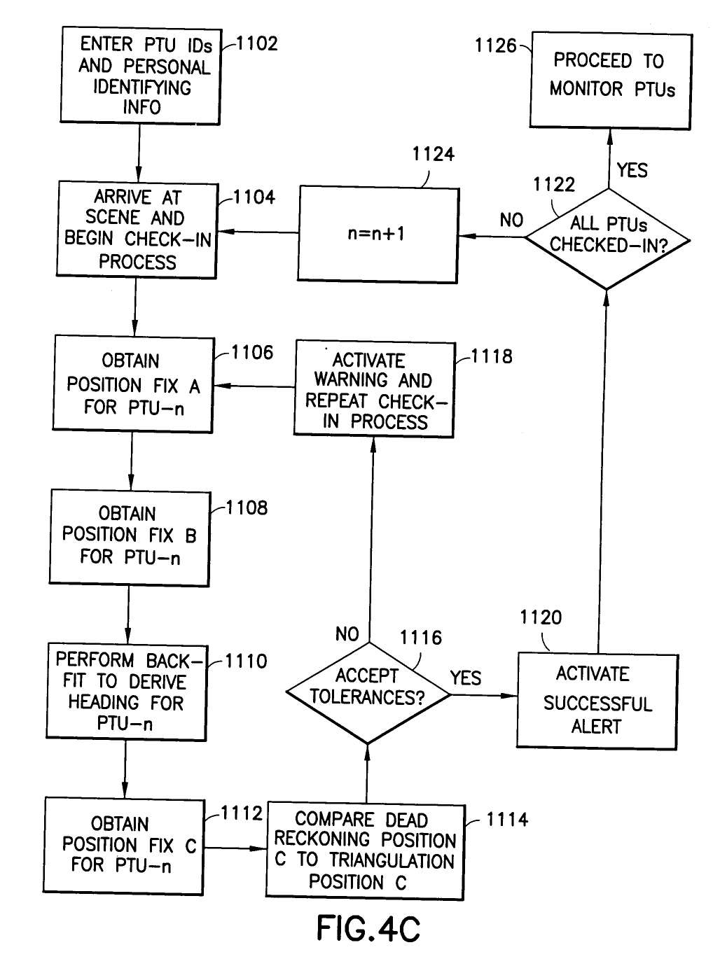

Three exemplary check-in procedures will now be described with reference to FIGS. 3a, 3b, and 4a-c. FIG. 3a shows a manual embodiment which involves the tracked individual to walk over to a check-in station 1101 preferably physically attached in a rigid fashion to the structure of MCS 1100. MCS 1100 can have on or more check-in stations 1101 attached to it for multiple persons 25. Check-in station 1101 has a cradle or cavity 1102 which receives wand 1104 to which cable 1103 is attached. Person 1106 with attached PTU 1105 simply picks up wand 1104 from cradle 1102 and engulfs the housing of PTU 1105 momentarily within cavity 1107. The relationship of cavity 1107 and housing 1105 is such that it only fits one way and is energized for two-way transfer only when properly seated. Since check-in station 1101 is in a known location and orientation relative to MCS 1100, if wand 1104 has an inertial tracking subsystem embedded (similar to that within a PTU), its location is known to MCS 1100 at all times. When data is transferred upon attachment to PTU 1105, it occupies the same location and orientation which is relayed to MCS 1100 and/or PTU 1105 as needed; personnel identification is also transferred to MCS 1100 at this moment. By returning wand 1104 to cradle 1102 after each check-in procedure, its home location is reset therefore avoiding any accumulated error in starting position. Multiple check-in stations 1101 can be attached to MCS 1100 to facilitate concurrent personnel check-ins. This system is more compatible with small crews with well defined missions such as police SWAT teams or rescue missions. Firefighters are less tolerant of any procedure that interferes with their normal activity at a fire scene.

An alternate check-in embodiment is illustrated in FIG. 3b. This embodiment utilizes GPS receiver 1151 and an electronic compass 1152 being integrated with PTU 1150 (including tracking subsystem 1153). The performance depends on the availability of adequate GPS signals at the MCS (e.g., outdoors) before the persons 25 enter a building. Since GPS does not provide heading information, compass 1152 or other device, is used. The latter can be similar technology to Precision Navigation's Palm Navigator 1.0 which uses a magnetic sensor. While this achieves an automatic check-in whereby the person 25 does not have to take any overt action, it has limited heading accuracy as provided by compass 1152 which is at the mercy of local magnetic field variations. Also, GPS 1151 cannot always be relied upon, even for outdoor reception in the canyons of a large city with many tall buildings.

Another alternate check-in embodiment is a triangulation scheme—which will be described with reference to FIGS. 4a-c. Such embodiment uses multiple (e.g., two or three) transceivers and “time-of-flight” calculations at MCS 1071 which is mounted on mobile platform 1070 (such as an emergency vehicle). As shown in FIG. 4a, two separate outdoor position fixes, A and B, are taken of each PTU at two different instances (e.g., about one second apart), which the MCS relates or calibrates to a master “origin” 1075 and a master “heading” 1076 on MCS 1071. In the present embodiment the MCS 1071 is integral with an emergency truck. The truck includes three or more transceivers 1072, 1073, 1074 for triangulating the two position fixes, A and B, as illustrated. Alternatively, the transceivers 1072, 1073, 1074 could be replaced with laser range finders or any other device(s) capable of identifying A and B. Once the position fixes A and B are taken, the MCS 1071 proceeds to calibrate the distance and direction of the person 25 and PTU.

FIG. 4b illustrates the top view of the “back-fitting” procedure for obtaining the original heading by a software routine preferably executed in MCS 1071. The accumulated path 1081 between the time of the first and second position fix is recorded as if it were derived from the master heading 1076. In other words, a vector 1082 is theoretically drawn from point A in the direction of the master heading to its terminus at point C. This vector 1082 should be the same length as vector 1080, the actual vector between points A and B, but it is pointing in the wrong direction in 3-D space; instead of being in the direction of actually traveled, the vector is positioned as per an initial heading of the reference master heading 1076. An angle of variance 1083 between vectors 1082 and 1080 is shown as a single angle; however, the variance may be in each of three dimensions. Therefore, the algorithm calculates three such angles, which when combined give the initial heading, which was previously unknown. Notably, this check-in is performed without the use of GPS nor a compass, and the procedure is totally transparent to the user.

The triangulation check-in process will now be summarized with reference to the flow chart of FIG. 4c. As illustrated therein, the process begins with the entering of the PTU (electronic) IDs into the MCS. In alternate embodiments the identifying information is stored in the PTU and upon powering up the PTU, the data is automatically sent to the MCS. With such data having being entered, the personal identifying information for the user is associated with each PTU. Step 1102. Upon receiving an emergency call, for example, the fire department arrives at the scene of a fire. Step 1104.

The MCS is instructed to begin the check-in process for the first PTU by obtaining the first position fix, A. Step 1106. The PTU ID is generically referred to as PTU-n, to indicate the nth PTU associated with the MCS. Each time the check-in process begins, the n-counter is reset. The process continues with obtaining the second position fix, B, for the same PTU-n. Step 1108. As noted above, software residing at the MCS continues by performing the back-fitting of the path of the person wearing PTU-n, thereby determining the heading of PTU-n. Step 1110.

The check-in process optionally continues with confirming the calibrated heading for PTU-n. More specifically, the MCS obtains a third position fix, C, by triangulation. Step 1112. The MCS compares the third position fix, C, which was determined using triangulation, to the position of the PTU-n, as determined by using dead reckoning. Step 1114. The MCS software then determines whether the difference in the two position readings for position C is within acceptable tolerances. Step 1116.

If the difference between readings is unacceptable, then the MCS indicates a failure, for example, an LED at the MCS and/or PTU-n (step 1118), and the check-in process is repeated for PTU-n (step 1106, et seq.). If the difference between the two readings is within acceptable tolerances, then the MCS continues by activating a successful check-in indicator, for example, an LED at the MCS and/or PTU-n (step 1120), and the MCS determines whether all PTUs have been checked-in (step 1122). If not, then the MCS increments counter-n (step 1124), and repeats the check-in process for the next PTU (steps 1106, et seq.).

If all PTUs have been checked-in, then the check-in process is deemed complete (step 1126) and the system proceed to monitor the positions of each PTU. It should be noted, however, that after each PTU is checked-in, the system immediately tracks the PTU's location and does not wait for all PTUs to be checked-in.

### Message Protocol

In alternate embodiments, no electronic ID is used to identify each PTU. Instead, each PTU transmits position and sensor data at a discrete frequency. The MCS, in turn, includes a multi-channel receiver or a wide band receiver with various filters used to identify the frequency, and thus associated PTU, of the received data.

It should be understood that although the present invention has thus far been described with reference to checking-in and tracking a single person 25, the present invention and embodiments may be suited for checking-in and tracking multiple persons. In such embodiments, each PTU is coded with an electronic identifier (ID). The MCS preferably contains memory, such as RAM, containing a database or table associating each electronic ID with a person 25 and preferably personal identifying information of such person, including for example, name, emergency contact information, preexisting health conditions, sensor data received from the PTU, and the like. The database would also associate each PTU with a position history.

More specifically, each PTU transmits the position and, if applicable, sensor data, in a predefined format. Such format includes a field for the PTU's electronic ID. Accordingly, upon the MCS receiving a packet of data, the MCS (and more particularly, software residing thereon) extracts the electronic ID and updates the database and, if applicable, the VDT, as appropriate.

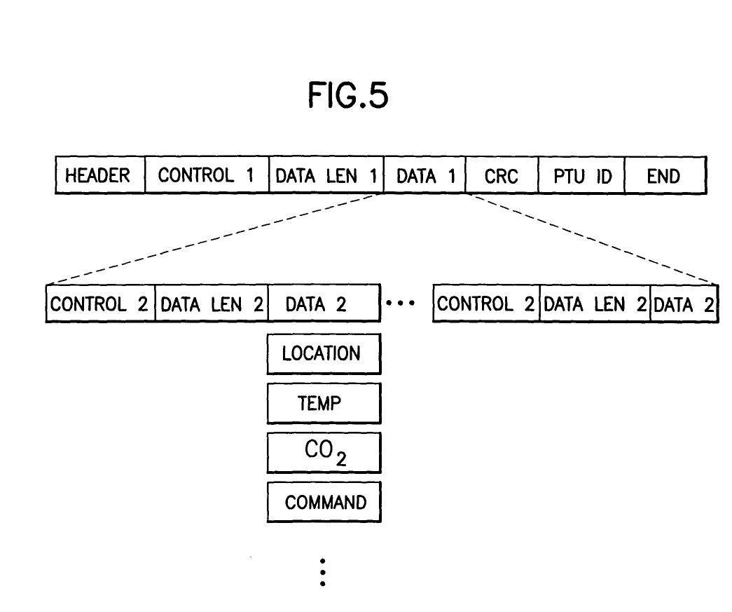

One exemplary message packet protocol will now be described in greater detail with reference to FIG. 5. As illustrated each message packet sent between a PTU and the MCS contains several fields, including a header field and end field, which contain predetermined values and indicate the beginning and end of a message packet, respectively. The message packet also includes a Control 1 field that indicates the type of message being sent by either the PTU or MCS, as the case may be. For example, the value of the control 1 field may indicate the message contains data from the PTU; the PTU has detected an internal fault or the data is bad; the PTU detected an alarm condition for a particular sensor or condition (e.g., low battery); and the like. In the case of messages sent by the MCS, whether the message is a command or request for data. The Control 1 field may also indicate that the message is simply an acknowledgement of the PTU or MCS having received a message from the other.

The Data length 1 field indicates the length of the Data 1 field. The CRC is used for detection of errors in the message, and employs any known technique, such as a checksum.

The PTU ID includes the ID of the PTU transmitting the packet or, if the packet is being transmitted by the MCS, the ID of the PTU to which the packet is being sent. Each PTU is programmed with its own ID so upon receiving a message from the MCS, each PTU can decode the PTU ID field to determine whether or not the PTU is the intended recipient. As noted above, certain embodiments do not use a PTU ID, but instead transmit messages at different frequencies or with different other signal or modulation characteristics. In such embodiments, the PTU ID field is necessary. It should be understood that where the PTUs communicate via RF transmissions, each PTU preferably transmits at a different frequency, thereby minimizing interference between transmissions and thereby differentiating between transmissions of different PTUs.

As illustrated the Data 1 field can include a sublevel of fields, including a Control 2 filed to indicate the particular type of data provided by the PTU (e.g., temperature, location/distance, carbon monoxide, fault, and the like), the type of data provided by the MCS (e.g., particular command or request and the like). The data length 2 field indicates the length of Data 2 field, which contains the actual data pertaining to the Control 1 and Control 2 fields, for example, the actual sensor data, the alarm indication and sensor data, the actual command (e.g., turn beacon on or off) and the like. The second level of the protocol may include multiple control and data fields, for example, one for distance/location and one or more for sensor data.

### MCS Display

As noted above, MCS preferably includes a VDT for displaying the location and/or path of each person (e.g., firefighter) 25. Such a display may simultaneously show all persons 25 of a particular group, such as all firefighters in a particular company, or may shown one person 25 at a time. Furthermore, the display may illustrate only current location of each person 25 or may indicate the path of each person 25 over a given time. When multiple persons 25 are represented on the display at once, each graphical representation is differentiated from others by a visual cue, such as PTU ID number; person's name or other identifying information (e.g., as stored at MCS).

Preferably, MCS has stored in memory a 3-D digital floor plan of the building into which the firefighters enter, and the floor plan is available on which to graphically superimpose information-bearing images of individual firefighters. The graphical image could be enhanced by such interactivity as provided by a touch screen.

Lacking a pre-existing 3-D floor plan, the MCS may acquire a facade image of a building optically at the fire ground, and from it by software infer a 3-D view of interior structural features, at a functionally valuable advisory level of detail/accuracy—to represent graphically at the fire ground (and/or via internet) as a tool for real-time firefighter location mapping other fire fighting needs. Inferred structural features may be include floor or hallway locations, indoor stair case locations (for example by window patterns), even potentially plumbing locations by roof-level standpipes. Other needed information, for example the depth (i.e. 3rd dimension) of a building, may be inputted by keypad for generating the graphic representation. Alternatively, all three dimensions, height (e.g., number of floors), width (e.g., in units of length, number of windows, etc.), and depth (e.g., in units of length, number of windows, etc.). Representations of other enclosed spaces, such as canyons, tunnels, and the like, can similarly be constructed based on user input, location data, and/or path data.

Furthermore, data from the sensors carried by the firefighters could be coupled to the location data and used in the same fashion to map real-time conditions within the building. Based on such conditions, the user of the MCS (e.g., the fire chief) could issue commands to cause the beacon to signal or provide other communication to the firefighters to indicate such conditions or to request the firefighters return to the MCS or take other action.

In one embodiment the display is a touch screen that enables the control user to simply touch an indication of a particular PTU/person 25 and gain information from the database, send a command to the person 25, cause a request for data to be sent to the PTU/person 25 and the like. In one embodiment, touching a PTU's path or location highlights that PTU's path to ease reference to it. A second touch removes the highlighting.

It should be understood that the information contained and/or displayed at the MCS may be further transmitted to other, remote locations for analysis and/or display. In such embodiments, the information may be relayed by the MCS or sent directly from the PTUs via any available communication network, including, for example, cellular network, Internet, wireless local area network, wired network and the like. Such remote availability of the data could be used for management oversight, training, supervision or any purpose enabled thereby.

Those skilled in the art will recognize that the method and system of the present invention has many applications, may be implemented in many manners and, as such, is not to be limited by the foregoing exemplary embodiments and examples. Moreover, the scope of the present invention covers conventionally known and future developed variations and modifications to the system components described herein, as would be understood by those skilled in the art.

What is claimed is:

1. A system for tracking persons or things, the system comprising:
one or more tracking units, each tracking unit associated with a person or thing and including one or more accelerometers and one or more gyroscopes;
a master control station (MCS) including a display for displaying a location of at least one of the tracking units, the MCS programmed to determine the location based on:
determination of a reference point and heading for the at least one tracking unit;
data from the accelerometers and gyroscope, which provides distance and direction information; and
aggregation of the distance and direction information.

2. The system of claim 1 wherein the MCS displays the location and path of the at least one tracking unit over a period of time.

3. The system of claim 1 wherein the MCS displays the location of multiple tracking units simultaneously, each of the displayed locations including an indication of the person or thing associated with the associated tracking unit.

4. The system of claim 1 wherein the MCS is programmed to determine the reference point and heading by manually positioning the tracking unit at a known location and in a known heading.

5. The system of claim 1 wherein the MCS is programmed to determine the reference point and heading by using GPS and a compass.

6. The system of claim 1 wherein the MCS includes a master heading and is programmed to determine the reference point and heading by triangulating multiple positions of the tracking unit and back-fitting a vector, based on the multiple positions and directed along the master heading, to the multiple positions.

7. The system of claim 1 wherein the tracking unit includes one or more sensors for collecting sensor data and generating an alarm condition based on collected sensor data.

8. The system of claim 7 wherein the MCS displays an indication of sensor data with location.

9. The system of claim 1 wherein the MCS is integral with an emergency vehicle and the tracking unit is worn by emergency personnel.

10. A method for tracking persons or things in an enclosed space, the method comprising:
associating each of multiple tracking units to a person or thing being tracked;
establishing a reference location and reference heading for the tracking unit based on a master reference location and master reference heading;
repeatedly acquiring data indicative of distance traveled by each tracking unit;
repeatedly acquiring data indicative of heading traveled by each tracking unit;
determining location of each tracking unit based on the data indicative of distance and the data indicative of heading; and
providing an indication of location of each tracking unit.

11. The method of claim 10 wherein the MCS has a master heading and wherein establishing a reference location and heading includes:
determining a first position fix;
determining a second position fix; and
back-fitting a path along the master heading, the path having a distance defined by the first and second position fixes, to the position fixes.

12. The method of claim 11 wherein determining the position fixes is based on triangulation.

13. The method of claim 10 further including constructing a representation of the enclosed space based on the location of each tracking unit.

14. The method of claim 13 wherein the enclosed space is a building and constructing a representation of the building includes identifying floors in the building.

15. The method of claim 14 wherein the enclosed space is a building and constructing a representation of the building includes identifying stairwells in the building.

16. The method of claim 15 wherein providing an indication of location of each tracking unit includes providing the indication relative to the representation of the building.
